(19) United States
(12) Patent Application Publication
(10) Pub. No.: US 2018/0200724 A1
(43) Pub. Date: Jul. 19, 2018

(54) APPARATUS FOR COMPACTING RECYCLABLE POLYMERIC MATERIAL

(71) Applicants: INSTITUTO NACIONAL DE TECNOLOGIA, Rio de Janeiro (BR); INDUSTRIA E COMERCIO DE MOLDURAS SANTA LUZIA LTDA, Braco do Norte (BR)

(72) Inventors: Gilberto Luiz ZANETTE, Braco do Norte (BR); Márcia Gomes De Oliveira, Rio de Janeiro (BR); Luiz Carlos Do Carmo Motta, Rio de Janeiro (BR); Welida José Barbosa, Rio de Janeiro (BR); Luisa Falcão Da Cruz, Rio de Janeiro (BR); Renato Lameri Sant'anna Mosci, Rio de Janeiro (BR); Daniel Gondim Pinheiro, Rio de Janeiro (BR); Luiz Fernando Vieira, Rio de Janeiro (BR); Fábio Moysés Lins Dantas, Rio de Janeiro (BR); Marcelo Ferreira Leão De Oliveira, Rio de Janeiro (BR); Fernanda Cristina Femandes Braga, Rio de Janeiro (BR); Renato De Barros Oliveira, Rio de Janeiro (BR)

(21) Appl. No.: 15/717,973

(22) Filed: Sep. 28, 2017

(30) Foreign Application Priority Data
Jan. 18, 2017 (BR) 202017001034-7

(51) Int. Cl. B02C 21/02; B30B 1/32; B30B 15/30; B02C 18/14

(52) U.S. Cl. CPC B02C 21/02; B02C 18/142; B30B 15/30; B30B 1/32

(57) ABSTRACT

The present utility model refers to a low density EPS crushing and compacting machine, providing its recycling with the aim to conserve the environment in educational and marketing campaigns for public locations. The machine basically comprises a feed dome, crusher and compactor and is characteristically provided for use by a user under training and/or without any familiarity with the operation and, therefore, equipped with more efficient safety devices and sized for easy transport and installable at exhibitions, events, trainings, educational action settings, etc.

### TECHNICAL FIELD

Recycling of polymers, particularly expanded polystyrene.

### BACKGROUND

The effort to reuse resources produced by industrial activity in order to eliminate wastes as well as its polluting effects on the environment is a global consensus. The concept of recycling has gained force proportional to the increased environmental impact of the industrial activity on the Planet. This lead to the dissemination of several awareness actions and ideas for the reuse of rejects and industrial wastes as well as materials before disposal directly on dumping grounds and landfills or simply abandoned to pollute lands and waters (http://www.scielo.br/pdfpo/v18n2/a08v18n2.pdf).

Also, recycling, particularly the recycling of plastics, has become commercially viable, which makes Brazil attain high recycling rates. However, the problem of pollution caused by plastics still persists. Only some types such as PET and PVC have achieved high recycling brands while others like PE and EPS still have low recycling rates.

The advance of recycling in Brazil is due to the profitability that certain disposed materials offer to those who recycle as well as to the buyer of the recycled product. A significant example of this fact is the aluminum and PET recycling market that return to the beverage industry and significantly reduce the production costs. However, labels, sealing tapes and covers have not suffered the same collection action as the champions aluminum and PET. In small quantities, these wastes are not attractive due to the low prices compared to the large quantities necessary to obtain a good profit (http://diarodonordeste.verdesmares.com.br/cadernos/negocios/momento-e-importante-para-o-mercado-da-reciclagem-no-brasil-1.137546).

Therefore, the issue of profitability associated to recycling alone is not capable of generating and disseminating actions that will effectively combat the increasing problem of industrial waste. On the other hand, the effects of the pollution caused by plastics increase and reach alarming levels.

For example, the phenomenon of plastification of the oceans. It is estimated that large quantities of plastic wastes, about 70%, may be deposited at the bottom of the oceans, many of which are fragmented into pieces so small that they are not quantifiable by the present conventional techniques. This affects the food chains of the marine ecosystems and impacts human consumption by the reduction of shoals due to the disappearance of species from the bottom of the chain. Another issue also consists of the plastification of the marine surface that drastically interferes in the marine algae and phytoplankton cycle and impacts the polluting effect of global warming (http://wwv.rtp.pt/noticias/especial-informacao/o-mundo-esta-cada-vez-mais-contaminado-por-plasticos_n841198).

It is still necessary to intensify the awareness and education actions of the Society in all of its segments in order to create a culture of care with what is disposed that will effectively reflect in the reduction of environmental damage especially at the rate such damages have reached nowadays.

Educational and awareness actions are widely disseminated throughout the country and are complemented by public policies that encourage environmental protection against the pollution of industrial wastes directly or indirectly.

Therefore, it would be a significant contribution to provide a device that enables the learner to have an experience in the context of Environmental Education that consolidates learning and at the same time comprises a relatively low cost and allows various applications and good mobility to serve more than one Environmental Education center.

The state of the art provides teachings that contemplates only the aspect of profitability associated to the practice of material recycling, namely:

The patent document CN204933595 refers to an equipment for recycling disposed plastic material that consists of a vertical feed, a permanent magnet and a spring for ejection, where the feed consists of a feed inlet and the upper internal part of the feed is equipped with a pivot while an element of longitudinal symmetry has a permanent magnet on the outer wall of the pivot on the left side of the feed and there is a crusher inside the pivot below the feed that provides a vertical crushing process.

The patent document CN104875299 refers to an EPS crusher that comprises a crushing device, namely a crushing drum and a rotation axis that connects to the motor on one end. The crusher faces the conveyor of a feed conveyor system.

The patent document US2010102475 refers to an EPS recycling and heat extruding system of the recycled material. The EPS recycling equipment comprises a conveyor of waste EPS material that feeds a crusher that in turn vertically feeds an extruder equipped with an outlet nozzle for the recycled product.

The patent document U.S. Pat. No. 5,922,835 refers to a method for compacting EPS, especially from waste, in which the material to be processed is brought into contact with a mixture of solvent and non-solvent substances of the EPS, producing a semi-liquid and transportable mass of smaller volume than the EPS.

The patent document WO2015118219 refers to a method for compacting thermoplastic material intended for recycling and a compactor apparatus. The device comprises a rotary unit placed between the first and second stationary panels. The rotary unit comprises a number of hollow chambers symmetrically arranged around a rotation axis and a number of heating elements surrounding the hollow chambers and preferably configured as coiled resistors. The compactor assembly comprises a crusher, a conveyor, a compactor and a compressor.

The patent document PI0601583-2 refers to a styrofoam compacting apparatus used to compact low density materials like expanded polypropylene, thus providing its recycling with the aim to conserve the environment. Technical Specifications: Built in carbon steel sheet. It has an auger compactor with three levels. For perfect compacting, the machine has electrical resistances attached to the outer housing for heating. The material to be compacted is introduced into the hopper (2), which by rotary action of the threads (6) presses the material against the walls of the machine (1) that, under the action of a heat source (5), compact the material definitively. The activation occurs through the use of a motor and reduction gear box; all manufactured in carbon steel SAE 1010/1020, and its power may vary according to necessity and its heating is generated by electrical resistance.

Firstly, the state of the art illustrated above comprises a machine for industrial purposes that utilize compacting by extrusion, processing more homogeneous material but most times too slow and expelling shapes difficult to transport. It has no protection against human access to dangerous parts of the machine.

Therefore, the teachings above are intended for the processing of waste material, plastics, aiming at an industrial processing scale and thus the equipment have large-scale dimensions. Therefore, these pieces of equipment have large dimensions and are not portable. Furthermore, these teachings do not contemplate the dissemination aspect of a recycling culture, for example, at events, exhibitions, schools, etc.

In order to provide equipment with this purpose, it is important to prioritize the portability aspect, that is, a transportable piece of equipment. Also, some safety precautions must be observed since the equipment can be operated by users with little or no professional training. It is also important for this equipment to enable visualization of the recycling process for a clear and direct understanding of the technique associating the problem to the solution.

### DESCRIPTION OF THE FIGURES

FIG. 1 shows a front view of the present utility model;

FIG. 2 shows a perspective view of the present utility model;

FIG. 3 shows a side view of the dome of the present utility model;

FIG. 4 shows an exploded view of the feed inlet of the present utility model.

### DETAILED DESCRIPTION

EPS compacting machines intended for recycling in the marked do not have a commercial proposal for educational and marketing purposes. The machines found in the market are intended for industrial applications and do not have esthetic and visual appeal for awareness campaigns. The machines in the market also have an extrusion compacting system that does not allow the output of material shaped for easy transport and storage such as the cube output that occurs with the developed machine in question.

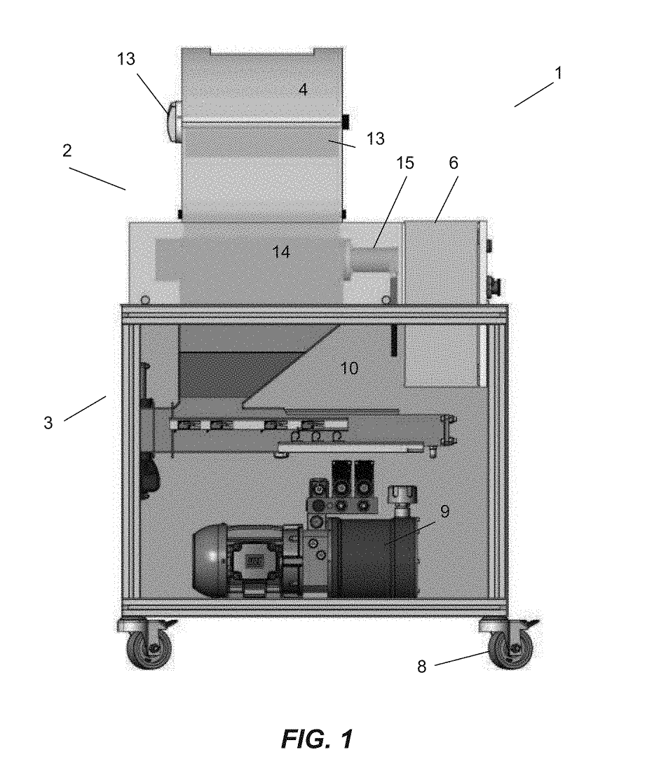

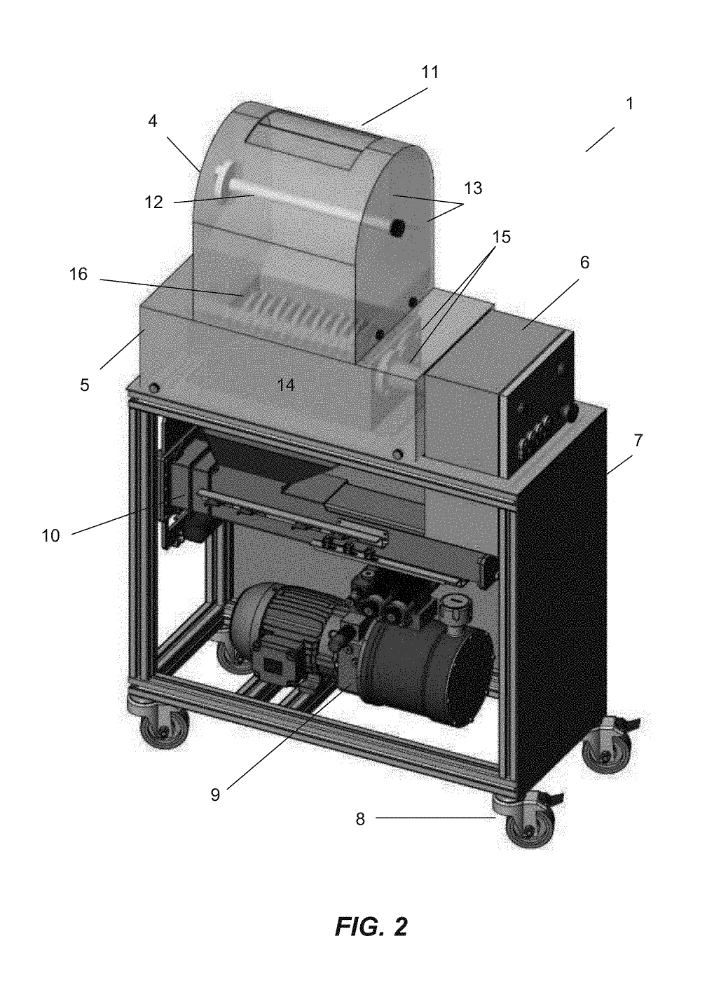

According to the figures alone, especially FIGS. 1 and 2, the crushing and compacting machine according to the present utility model comprises a structure (1), which comprises an upper part (2) and a lower part (3), wherein the upper part has dome section (4), a crushing section (5) and an activation and control section (6). The lower part comprises a housing (7) equipped with rollers (8), motor section (9) and a storage and compacting section (10).

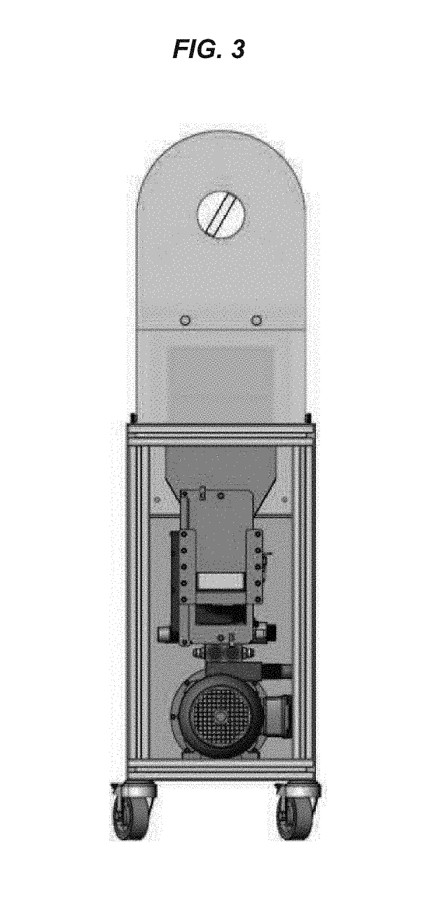

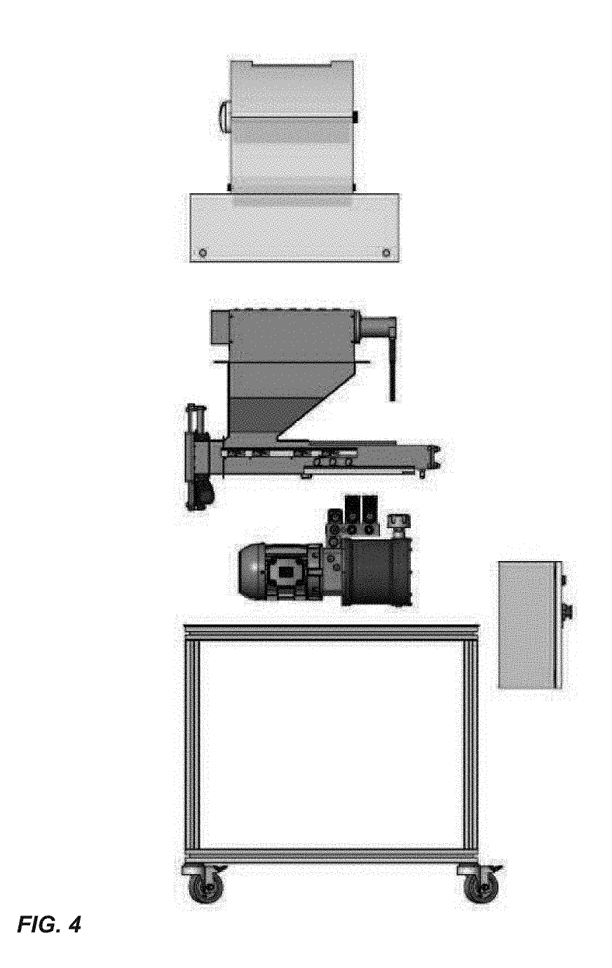

According to the present utility model, especially regarding FIGS. 3 and 4, the crushing and compacting machine is built in carbon steel, the machine has a crushing module (2) and another compacting module (3). On top of the crusher (14) is a dome (4) for feeding and safety made of acrylic. The dome is provided in transparent polycarbonate and a cubic shape. When the lever is activated, the tray is positioned in the horizontal to receive the EPS. Once the lever is released, the tray is repositioned in the vertical position to enable the conveying of the EPS to the crusher.

The input of low density EPS material is performed by a horizontal cylindrical dome (4) with upper opening (11) and a revolving rotation axis (12). Attached to the axis are three blades (13) that rotate inside the dome (4) to allow the entry of material and prevent human access to the crusher (14).

The crusher (14) has two parallel axes (15) with coupled blades (16) to each axis, the blades (16) along the axis are at 90° and spaced to intercalate with the blades of the other axis. The crusher (14) is activated by a hydraulic motor (15) with low rotation and high torque, capable of crushing the pieces of EPS of 10 to 30 kg/m³.

Under the crusher (16) is a storage area (160 with a funnel (17) to feed a square-shaped hydraulic press (18), the storage area serves to ensure a continuous process of the machine if necessary, storing the crushed material while a whole compression cycle is completed.

The hydraulic cylinder moves over the material to reduce its volume, increasing the output density.

The acrylic dome (4) is transparent to allow greater interactivity between the user and the crushing process. The crusher and compactor (1) are activated by a same hydraulic system that activates the motor and piston.

1. Crushing and compacting machine characterized by a structure (1), which comprises an upper part (2) and a lower part (3) wherein the upper part has a dome section (4), a crushing section (5) and an activation and control section (6). The lower part comprises a housing (7) equipped with rollers (8), motor section (9) and storage and compacting section (10).

2. Machine, according to claim 1, characterized by comprising a crushing module (2) and a compacting module (3) and on top of the crusher (14) is a dome (4) attached to for feeding and safety.

3. Machine, according to claim 1, characterized by the input of low density EPS material performed by a horizontal cylindrical dome (4) with upper opening (11) and a revolving rotation axis (12) on which three blades (13) are attached, rotating inside the dome (4) to allow the entry of material and prevent human access to the crusher (14).

4. Machine, according to claim 1, characterized by crusher (14) having two parallel axes (15) with blades (16) coupled to each one, the blades (16) along the axis are at 90° and spaced to intercalate with the blades of the other axis, wherein the activation of the crusher (14) is performed by the hydraulic motor (15) with low rotation and high torque, capable of crushing the EPS pieces of 10 to 30 kg/m³.

5. Machine, according to claim 1, characterized by a storage area (16) below the crusher (16) with funnel (17) to feed a square-shaped hydraulic press (18).

6. Machine, according to claim 1, characterized by a transparent acrylic dome (4) to allow greater interactivity between the user and the crushing process.

7. Machine, according to claim 1, characterized by the activation of the crusher and compactor (1) through a same hydraulic system that activates the motor and piston.
